(19) United States
(12) Patent Application Publication
(10) Pub. No.: US 2014/0279993 A1
(43) Pub. Date: Sep. 18, 2014

(54) Clarifying User Intent of Query Terms of a Search Query

(71) Applicant: MICROSOFT CORPORATION, Redmond, WA (US)

(72) Inventors: Daniel Bernhardt, London (GB); Antonio Gulli, Pisa (IT); Rui Andre Augusto Ferreira, London (GB); Elbio Renato Torres Abib, Bellevue, WA (US); Ashish Gandhe, Bellevue, WA (US); Srinivas Chappidi, Redmond, WA (US)

(73) Assignee: MICROSOFT CORPORATION, Redmond, WA (US)

(21) Appl. No.: 13/804,733

(22) Filed: Mar. 14, 2013

(51) Int. Cl. G06F 17/30

(52) U.S. Cl. CPC G06F 17/30864
USPC 707/706; 707/771

(57) ABSTRACT

Systems and methods for clarifying a computer user's intent with regard to one or more query terms of a search query are presented. Often, one or more query terms of a search query are ambiguous and/or unclear. As presented herein, upon identifying a query term in the search query that is unclear, clarification data is obtained and presented to the computer user by way of a clarification user interface. The computer user is able to identify one or more aspects of the computer user's intent, intent clarifications, with regard to the query term through the clarification user interface. Upon instruction by the computer user, the search query, along with the intent clarifications, is submitted to a search engine and the search results obtained from the search engine are presented to the computer user.

### BACKGROUND

Those who have interacted with an online search engine will recognize that it can be difficult to enter a search query specific enough to properly identify the subject matter sought. Because of this, people must often subsequently refine the search query one or more times before the desired results are shown. When the person must refine and resubmit a search query, the frustration level of the person with regard to the search engine can increase substantially.

One of the reasons why the person must often re-enter a search query is that the query terms that a person enters are frequently indefinite and/or ambiguous. Quite often, the person entering the search query is unaware of the indefinite and/or ambiguous nature of any given term that is entered.

### SUMMARY

The following Summary is provided to introduce a selection of concepts in a simplified form. These concepts will be further described below in the Detailed Description. The Summary is not intended to identify key features or essential features of the claimed subject matter, nor is it intended to be used to limit the scope of the claimed subject matter.

A method for clarifying a computer user's intent with regard to one or more query terms of a search query is presented. Often, one or more query terms of a search query are ambiguous and/or unclear. As presented herein, upon identifying a query term in the search query that is unclear, clarification data is obtained and presented to the computer user by way of a clarification user interface. The computer user is able to identify one or more aspects of the computer user's intent, each aspect being an intent clarification, with regard to the query term through the clarification user interface. Upon instruction by the computer user, the search query, along with the intent clarifications, is submitted to a search engine.

Computer-readable media bearing computer-executable instructions is presented. The execution of the instructions by a processor on a computing system carries out a method for clarifying a computer user's intent with regard to one or more query terms of search query. Upon identifying a query term in the search query that is unclear, clarification data is obtained and presented to the computer user by way of a clarification user interface. The computer user is able to identify one or more aspects of the computer user's intent, intent clarifications, with regard to the query term through the clarification user interface. After instruction by the computer user, the search query, along with the intent clarifications, is submitted to a search engine.

A computer system configured to clarify a computer user's intent with regard to one or more query terms of search query is presented. The computer system includes a search component that obtains a search query from a computer user. A query term analyzer identifies an unclear query term of the search query as a first query term to be clarified. The search component that obtains clarification data corresponding to the first query term and presents the clarification data to the computer user for selection by way of a clarification user interface. Clarification data selected by the computer user is associated with the first query term as intent clarifications. The search query, along with the intent clarifications, is submitted to the search engine and the search results obtained from the search engine are presented to the computer user.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a block diagram illustrating an exemplary networked environment suitable for implementing aspects of the disclosed subject matter;

FIGS. 2A-2D are pictorial diagrams illustrating the display of exemplary clarification views in which the computer user may provide explicit clarification regarding user intent of a search query;

FIG. 3 is a block diagram illustrating the exemplary interaction between the user computer and the search engine in clarifying the user intent of a search query;

FIG. 4 is a flow diagram illustrating an exemplary routine for clarifying user intent in conjunction with entry of the search query;

FIG. 5 is a flow diagram illustrating an exemplary general routine for processing clarification requests from computer users;

FIG. 6 is a flow diagram illustrating an exemplary routine for responding to a search query that includes one or more intent clarifications;

FIG. 7 is a block diagram illustrating an exemplary user computer configured to clarify user intent during query formulation; and

FIG. 8 is a block diagram illustrating an exemplary search engine configured to provide clarifying content to a computer user for clarifying user intent during query formulation.

### DETAILED DESCRIPTION

For purposes of clarity, the use of the term “exemplary” in this document should be interpreted as serving as an illustration or example of something, and it should not be interpreted as an ideal and/or a leading illustration of that thing.

A search query should be interpreted as a set of words, numbers and/or query terms that correspond to one or more topics or entities. Query terms may be comprised of one or more words (including abbreviations), numbers or symbols that correspond to a particular topic. A search query may include multiple query terms such that the search query is directed to a plurality of entities and/or topics but a query term, once the computer user's intent is properly established, corresponds to one specific topic or entity. Each query term may have one or more aspects which, when clarified, narrow the scope of the corresponding topic/entity. Each clarified aspect of a query term is referred to as an intent clarification. To say that a query term is unclear implies that the user's intent with regard to the query term is unclear, i.e., without more clarification the query term can be interpreted as corresponding one more than one topic or entity. A query term is unclear when the term is ambiguous, indefinite, incomplete, misspelled, and the like. A query term is ambiguous when the query term corresponds to more than one specific topic or entity. For example, a query term “ravens” may correspond to a particular type of bird or a professional football team. A query term is indefinite when, without more (such as an intent clarification) the meaning of the query term can't be defined/determined. For example, the query term “the former President” is indefinite because there are many former presidents and, without more, the query term cannot be related to a specific entity. To say that a query term is clarified implies that the computer user has explicitly indicated the computer user's intent with respect to at least one aspect of the query term.

Turning to the figures, FIG. 1 is a block diagram illustrating an exemplary networked environment 100 suitable for implementing aspects of the disclosed subject matter, particularly in regard to clarifying user intent during search query formulation. The illustrative networked environment 100 includes one or more user computers, such as user computers 102-106, connected to a network 108, such as the Internet, a wide area network or WAN, and the like. Also connected to the network 108 is a search engine 110 configured to provide search results in response to search queries received from one or more persons/computer users, such as computer user 101 by way of user computer 102 over the network 108. In addition to providing search results in response to a search queries, the search engine 110 is also configured to provide data to the user computers 102-106 as part of clarifying a computer user's query intent during query formulation. Of course, while not shown, all or part of the disclosed subject matter, including those features described below, may be implemented on a computer user's computer (such as user computer 102-106) and work separately or in conjunction with the search engine 110 in clarifying user intent with regard to one or more query terms of a search query.

Those skilled in the art will appreciate that, generally speaking, a search engine 110 corresponds to an online service hosted on one or more computers, or computing systems, located and/or distributed throughout the network 108. The search engine 110 receives and responds to search queries submitted over the network 108 from various computer users, such as computer user 101 using user computer 102 over the network 108. In particular, responsive to receiving a search query from a computer user, the search engine 110 obtains search results information related and/or relevant to the received search query (as defined by the terms of search query.) The search results information includes search results, e.g., references (typically in the form of hyperlinks) to relevant and/or related content available at various network locations located throughout the network 108, such content sites 112-116. The content sites may include (by way of illustration and not limitation): news outlets/portals/sources, such as news content site 112; online shopping sites, such as online shopping site 114; social media and networking sites, such as social site 116; educational and research sites (not shown); and the like. As will be described in more detail below, the search engine 110 also responds to requests from various computers, including user computers 102-106, for data used by the various computers to clarify a computer user's query intent during query formulation.

According to aspects of the disclosed subject matter, in conjunction with a computer user entering a search query, one or more of the query terms of the search query are analyzed and a determination is made as to whether the computer user's intent with respect to a particular query term should be clarified. When the determination is made to clarify an “unclear” query term (i.e., a query term that is ambiguous, indefinite, potentially misspelled, and the like) a user interface is presented to the computer user through which the computer user can clarify the user's intent with regard to the particular query term. Clarifying a query term of a search query does not cause the search query to be submitted. However, once a search query is sufficiently clarified (i.e., a predetermined threshold number of query terms in the search query have been clarified as to the user's intent) the search query could be submitted without further user interaction. Further still, generally speaking the search query does not modify the search query as presented to the computer user. To more fully illustrate the presentation of one or more user interfaces to clarify query terms of a search query, reference is now made to an example.

FIGS. 2A-2D are pictorial diagrams illustrating the display of exemplary clarification views in which the computer user may provide explicit clarification regarding the computer user's intent of a query term. Turning first to FIG. 2A, this figure includes an exemplary search window 200 in which a computer user may enter a search query in a search query box 202. As shown in search query box 202, the following discussion of FIGS. 2A-2D will be based on the exemplary search query “Restaurants in springf” to illustrate the presentation of clarification user interfaces to clarify the user intent with regard to query terms of the exemplary search query. Clearly, “springf” is an incomplete (or misspelled) word that is intentionally used to illustrate that, according to aspects of the disclosed subject matter, the analysis of query terms may be made on query terms as well as partially completed query terms. It should also be understood that the analysis of query terms in a search query may be an ongoing process concurrent (or substantially concurrent) with the entry of a search query, may be made after a computer user has entered a search query but before the search query has been submitted to a search engine, during a pause in the entry of a search query, or any combination of these. Accordingly, the analysis of query terms in the search query (whether the analysis occurs after the search query is entered but before submission to a search engine, or concurrently with the entry of the search query) is said to be made “in conjunction with entry of the search query.”

Continuing with the example set forth in regard to FIG. 2A, in conjunction with the computer user entering the search query “Restaurants in springf” in the search query box 202, an analysis suggests that the query term (in this case the partial query term) “springf” is unclear and can be clarified by the computer user. Accordingly, a clarification user interface, such as clarification view 206, is presented to the computer user in which the computer user may identify the user's intent with regard to the partial query term “springf.” For this example, within the clarification view 206 there are several clarification options, including options 208-212, from which the computer user may choose to identify the computer user's intent with regard to the partial query term. In addition to the clarification options, the computer user is also presented with an option 214 to indicate that none of the presented options, including options 208-212, convey the computer user's intent. Optionally, the query term that is the target of the clarification view 206 may be highlighted in some manner, such as shown with highlighting 204. For purposes of this example, we will assume that the computer user selects clarification option 212 as a clarification to the user's intent with regard to “springf.”

After the computer user has provided explicit feedback regarding the intent of an aspect for a query term through a clarification user interface, such as in regard to the query term “springf” in clarification view 206, the search query may be optionally updated to reflect this clarification. Updating the search query occurs primarily for incomplete or misspelled query terms. For example, after the computer user selects clarification option 212, corresponding to “Springfield, Ma,” the partial query term may be automatically completed. FIG. 2C illustrates the resulting updated search query, “Restaurants in Springfield, Ma,” in search query box 202. Completing partial query terms and/or misspelled query terms based on explicit user selection of clarification options are some examples where the search query is modified through clarification of user intent.

In regard to analyzing the search query to identify a query term that could be clarified through the use of one or more clarification user interfaces (such as clarification views 206 and 222), the process is not limited to a single query term. Moreover, the analysis is not constrained to process the query terms of the search query in any particular order. According to one embodiment, the order in which multiple query terms in a search query are clarified is based on a confidence value that the intent of a given query term can be successfully determined through interaction with the computer user via a clarification user interface. Thus, the query terms having the highest corresponding confidence values would be clarified first. Further still, in one embodiment, no effort is made to clarify query terms having a corresponding confidence value that falls below a particular, predetermined threshold.

Continuing the example above and as shown in FIG. 2C, after having identified the particular city that the computer user intended by the partial query term “springf,” the ongoing analysis of query terms has selected the query term “Restaurants,” as indicated by highlighting 220, for clarification. Thus, a clarification user interface, clarification view 222, is presented to the computer user to identify one or more aspects of the computer user's intent with regard to the query term “Restaurants.” As shown in clarification view 222, there are multiple aspects of intent that a computer user can clarify, including a type of cuisine (as indicated by heading 224), a price range that the computer user would like to consider, as well as the type of ambience for the restaurant (as indicated by heading 226). In addition to the various options that the computer user may select, the computer user is given an option to choose none of the options for a particular category (as indicated by clarification options 228 and 230) as well as an option to decline to provide clarification for all of the options, as indicated by clarification option 232. Of course, this exemplary clarification view 222 is just an illustrative example of a clarification user interface and should not be viewed as the only arrangement or type of information that may be presented through clarification view. Further, while the clarification view 222 presents discrete options from which a computer user can select, in an alternative embodiment the computer user may be provided with the ability to supply an option, such as an option that is not listed on the clarification view. For example (not shown), the clarification view 22 may include a text entry field in which the computer user could enter a cuisine that is not listed, such as “Chinese” in order to provide an intent clarification.

As part of the analysis of the particular query term, various facets or aspects of a particular category may be pre-generated and/or predetermined in order to facilitate rapid presentation of clarification user interfaces. Similarly, the type of clarification user interfaces that may be presented to the computer user may be predetermined/pre-generated. For example, upon determining that the computer user's intent for the query term “Restaurants” could be clarified, a predetermined set of aspects generally corresponding to restaurants could be used to determine the various clarification options presented in a given clarification user interface, such as clarification view 222. Further still, contextual information corresponding to the computer user, whether it is explicitly identified or implicitly identified, may be used to determine values, ranges and/or other clarification options for a given query term. Thus, the combination of predetermined query options associated with a particular query term as well as contextual information corresponding to the computer user may be combined to populate the clarification options for a given clarification user interface, such as clarification view 222. The contextual information corresponding to the computer user may include, by way of illustration and not limitation: the computer user's search query, click and/or browsing history; the geographical location of the computer user; the computer user's demographical information; interests (both explicitly obtained and implicitly derived); education; and the like.

In addition to providing discrete, selectable options (such as buttons or menu items) to identify aspects of the computer user's intent with regard to a query term, other types of interactive clarification user interfaces may be presented. For example and in regard to FIG. 2D, with regard to the query term “Restaurants” another aspect that could be clarified is the particular region of the identified city in which a restaurant is sought. Thus, clarification view 234 is presented showing a map 240 of the clarified city, Springfield, Mass., in which a user can simply select one of the various neighborhoods (such as neighborhoods 236 and 238) of the city, as part of clarifying the user intent in locating a suitable restaurant. In addition to the various selectable buttons (such as clarification options 208-212 of FIG. 2B) and maps, any number of other types of user interfaces may be used to obtain clarification information from the computer user with regard to a query term including, but not limited to, scrollbars, drop-down menus, text input fields, toggle switches, field selectors, and the like. Depending on the particular user input paradigm of the user computer, a computer user may select clarification options from a clarification user interface using a mouse, a keyboard, a touch-enabled device, by voice and/or gaze input, motion (of the device or of the computer user), and any other type of user input. Further still, the selectable options need not be limited to textual options. For example, for a query, “President Roosevelt,” the clarification view may present an image of President Theodore Roosevelt and an image of President Franklin D. Roosevelt for selection by the computer user. The images may, optionally, include descriptive text to further assist the computer user in distinguishing between the two so that the computer user may accurately clarify the intent of the query. Accordingly, the examples presented in FIGS. 2A-2D, including clarification views 206, 222, and 234, should be viewed as illustrative examples of clarification user interfaces and not viewed as limiting examples of the disclosed subject matter.

As suggested above, rather than simply selecting an alternative search query as one would do in selecting an alternative query during query auto-completion (where a process attempts to “guess” what the completed search query will be), according to various embodiments of the disclosed subject matter the computer user is directed towards clarifying the computer user's intent with regard to one or more query terms (including partial and misspelled query terms) of a search query. The search query is not necessarily modified except in regard to completing partial query or replacing misspelled query terms (based on explicit computer user clarification). Indeed, one focus of the disclosed subject matter is to clarify the computer user's intent with regard to one or more of the query terms of the search query. Thus, in contrast to selecting a “completed search query” as one would in an auto-completion mode, according to the disclosed subject matter the computer user submits the search query to a search engine 110, such as through execution button 242. In submitting the search query to the search engine, both the search query as well as any intent clarifications obtained from the computer user are provided to the search engine 110. Also, while the query terms discussed in regard to the example of FIGS. 2A-2D have been single word query terms, this is illustrative and not limiting upon the disclosed subject matter. Query terms may be comprised of any number of words (including abbreviations), numbers, and/or symbols. For example, a single query term may be “Mt. Rainier” or “Mount St. Helens,” even though they are comprised of multiple words. Differentiating between words in a search query versus identifying the query terms of the search query is performed in conjunction with or as part of the analysis of the search query, such as by a search query processor 716 of FIG. 7.

According to additional aspects of the disclosed subject matter, the information provided by the computer user to clarify a query term may be used as feedback (positive and/or negative) to update preferences for the computer user. Those skilled in the art will appreciate that a search engine 110 will often maintain a user profile for a plurality of computer users in order to provide more relevant search results to a given computer user.

Turning now to FIG. 3, FIG. 3 is a block diagram 300 illustrating an exemplary interaction between a user computer 102 and a search engine 110 in clarifying the user intent of a search query, such as described above in regard to the example of FIGS. 2A-2D. In the exemplary interaction, a computer user 101 using a computer 102 enters a search query. In conjunction with entering the search query, a query term analyzer 718 operating on the user computer 102 identifies one or more query terms where the computer user's intent can be clarified. In a non-limiting embodiment, the query term analyzer 718 obtains clarification data for a query term from a clarification data cache 720 available on the user computer 102. In an alternative embodiment, the query term analyzer 718 submits a clarification data request that includes a query term 302 to a search engine 110. In response, the search engine 110 identifies and returns clarification data 304 corresponding to the query term the user computer 102. As already indicated, the clarification data request may also include, user identification, contextual information, and previously identified intent clarifications with the query term 302 so that the search engine can identify and return the most relevant clarification data 304.

In yet another embodiment, the query term analyzer 718 accesses the clarification data cache 720 to obtain clarification data 304 stored there as well as obtain additional clarification data from the search engine 110. The clarification data 304 (combined from both sources) is presented to the computer user 101 by way of one or more clarification user interfaces (such as clarification views 206, 222, and 234) and the user is able to clarify computer user intent corresponding to a particular query term. Upon activation by the computer user 101, the search query 306, along with any intent clarifications obtained from the computer user via one or more clarification user interfaces, is submitted to the search engine 110 which, in response to the search query, identifies appropriate search results (improved according to the identified intent clarifications) and returns the search results 308 to the user computer 102 for presentation to the computer user 101 on the user computer 102.

Turning now to FIG. 4, FIG. 4 is a flow diagram illustrating an exemplary routine 400 for clarifying user intent in conjunction with entry of a search query. Beginning at block 402, a looping construct is begun to analyze the query terms in a search query. This looping construct may repeat until there are no more query terms to be clarified or until the search query is submitted to the search engine 110. At block 404, the routine 400 analyzes the query terms in the search query. At block 406, the routine 400 identifies a query term that is unclear. At decision block 408, a determination is made as to whether a confidence value representing the confidence that the query term may be clarified by the computer user is above a predetermined threshold value. If the confidence value of clarifying the query term does not exceed the predetermined threshold value, the routine 400 returns to block 402 where the process repeats until there are no more query terms to clarify or until the computer user indicates that the search query should be submitted to the search engine 110. Further still, the process may terminate after a predetermined amount of time has passed such that the computer user is not forced to continue to clarify for a lengthy period of time. Of course, in various configurations, even when the computer user indicates that the search query should be submitted to the search engine 110, in some circumstances the system may be configured such that a clarification view is presented to force or encourage the computer user to clarify one or query terms of the search query.

In the alternative, at decision block 408, if the confidence value exceeds the predetermined threshold value, the routine proceeds to block 410. At block 410, clarification data is obtained corresponding to the identified query term of the search query. As previously discussed, clarification data 304 may be obtained from a local clarification data cache 724 on the user computer 102, from the search engine 110, or a combination of the two. At block 412, the clarification data is presented to the computer user by way of one or more clarification user interfaces. At block 414, the computer user's selection of the presented clarification data is obtained. At block 416, the selected clarification data is associated with the identified query term as one or more intent clarifications. Thereafter, the routine 400 returns again to block 402 and repeats as discussed above.

From block 402, the routine 400 proceeds to block 418 upon receiving indication from the computer user to submit the search query to the search engine 110. Accordingly, at block 418, the search query with the associated intent clarifications (as well as user identification and contextual information) is submitted to the search engine 110. In response to submitting the search query, at block 420, the search results 308 from the search engine 110 are obtained/received. At block 422, the search results 308 obtained from the search engine 110 are presented to the computer user 101 on the user computer 102. Thereafter, the routine 400 terminates.

FIG. 5 is a flow diagram illustrating an exemplary routine 500, as implemented on the search engine 110 or other suitably configured clarification service, for processing clarification requests from computer users. Beginning at block 502, a request for clarification data corresponding to a query term is received from a computer user 101 by way of a user computer, such as user computer 102. As previously mentioned, the request for clarification data corresponding to a query term can be accompanied by user identification information corresponding to the computer user such that the search engine 110 may identify and use any relevant user preference information in identifying clarification data for the query term. In addition to user identification information, the clarification data request may also include contextual information corresponding to the computer user. This contextual information may similarly be used (in conjunction with all other obtained information) in obtaining relevant clarification data for the query term. In addition to these two items of information, any previously obtained intent clarifications corresponding to the query term may also be submitted. As indicated by the example described in regard to FIGS. 2A-2D, a single query term may have many aspects that are suitable for clarification. For example, as was suggested above, “Restaurants” has several aspects that are suitable for clarification including a city, a region in/near the city, a type of food/cuisine, a price range, an ambience, and the like. Based on all of the information provided in the query term clarification request, at block 504, the search engine 110 determines/identifies clarification data corresponding to the query term. At block 506, the clarification data is returned to the user computer where, as described above in regard to routine 400, a clarification user interface may be presented such that the user can clarify the user's intent with regard to the query term. Thereafter, the routine 500 terminates.

In addition to responding to query term clarification requests, a search engine 110 may also be configured to field search queries that include intent clarifications. FIG. 6 is a flow diagram illustrating an exemplary routine 600 for responding to a search query that includes one or more intent clarifications. Beginning at block 602, a search query is received from a computer user. The search query, in this case, includes one or more intent clarifications associated with one or more of the query terms of the search query. At block 604, the search engine identifies search results corresponding to the search query in light of the clarification data associated with the various query terms of the search query. At block 606, the search engine generates one or more search results pages according to the identified search results. Thereafter, at block 608, one or more of the search results pages are returned to the computer user 101 (via the user computer 102) and the routine 600 terminates.

Regarding routines 400, 500 and 600, while these routines are expressed in regard to discrete steps, these steps should be viewed as being logical in nature and may or may not correspond to any actual and/or discrete steps of a particular implementation. Nor should the order in which these steps are presented in the various routines be construed as the only order in which the steps may be carried out. Moreover, while these routines include various novel features of the disclosed subject matter, other steps (not listed) may also be carried out in the execution of the routines. Further, those skilled in the art will appreciate that logical steps of these routines may be combined together or be comprised of multiple steps. Steps of routines 400, 500 and 600 may be carried out in parallel or in series. Often, but not exclusively, the functionality of the various routines is embodied in software (e.g., applications, system services, libraries, and the like) that is executed on computer hardware and/or systems as described below in regard to FIGS. 7 and 8. In various embodiments, all or some of the various routines may also be embodied in hardware modules on a computer system.

While many novel aspects of the disclosed subject matter are expressed in routines embodied in applications (also referred to as computer programs), apps (small, generally single or narrow purposed, applications), and/or methods, these aspects may also be embodied as computer-executable instructions stored by computer-readable media, also referred to as computer-readable storage media. As those skilled in the art will recognize, computer-readable media can host computer-executable instructions for later retrieval and execution. When executed on a computing device, the computer-executable instructions stored on one or more computer-readable storage devices carry out various steps, methods and/or functionality, including those steps, methods, and routines described above in regard to routines 400, 500 and 600. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this disclosure, however, computer-readable media expressly excludes carrier waves and propagated signals.

FIG. 7 is a block diagram illustrating an exemplary user computer, such as user computer 102, configured to clarify user intent in conjunction with search query formulation/entry. As shown in FIG. 7, the user computer 102 includes a processor 702 (or processing unit) and a memory 704 interconnected by way of a system bus 710. As those skilled in the art will appreciated, memory 704 typically (but not always) comprises both volatile memory 706 and non-volatile memory 708. Volatile memory 706 retains or stores information so long as the memory is supplied with power. In contrast, non-volatile memory 708 is capable of storing (or persisting) information even when a power supply is not available. Generally speaking, RAM and CPU cache memory are examples of volatile memory whereas ROM and memory cards are examples of non-volatile memory.

The processor 702 executes instructions retrieved from the memory 704 in carrying out various functions, particularly in clarifying user intent with regard to one or more query terms of a search query. The processor 702 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: mini-computers; mainframe computers, personal computers (e.g., desktop computers, laptop computers, tablet computers, etc.); handheld computing devices such as smartphones, personal digital assistants, and the like; microprocessor-based or programmable consumer electronics; and the like.

The system bus 710 provides an interface for search engine's components to inter-communicate. The system bus 710 can be of any of several types of bus structures that can interconnect the various components (including both internal and external components). The user computer 102 further includes a network communication component 712 for interconnecting the user computer with other computers (including, but not limited to, a search engine 110) as well as other devices on a computer network 108. The network communication component 712 may be configured to communicate with an external network, such as network 108, via a wired connection, a wireless connection, or both.

Also included in the user computer 102 is a search component 714. The search component 714 is responsible for interacting with the computer user 101 in obtaining the search query from the computer user, presenting clarification user interfaces to the computer user, submitting a search query with corresponding intent clarifications and other information as described above to the search engine 110, and presenting the search results received from the search engine in response to the search query. In one embodiment, the search component is a web browser executing on the user computer displaying a search interface with the search engine 110. The search window 200 of FIG. 2A is a non-limiting example of a search interface that may be displayed on a web browser on the user computer 102.

The search query parser 716 operates in conjunction with the search component 714 to identify one or more query terms in the search query, including query terms that are unclear as to the user's intent and may benefit from clarification. The search query parser 716 provides information regarding the identified query terms to the query term analyzer 718. For its part, the query term analyzer 718, as suggested above, determines which of the identified query terms are unclear as to the user intent and should be clarified through use of clarification user interfaces. The clarification data cache 720, being an optional component, may include cached clarification data corresponding to a plurality of query terms. As mentioned above, the query term analyzer 718 may obtain clarification data 304 from both the clarification data cache 720, from the search engine 110 via a clarification data request, or combination of the two.

FIG. 8 is a block diagram illustrating an exemplary search engine 110 configured to provide clarifying content to a computer user for clarifying user intent during query formulation as well as responding to search queries that include intent clarifications. The search engine 110 includes a processor 802 (or processing unit) and a memory 804 interconnected by way of a system bus 810, analogous to the user computer 102 described above in regard to FIG. 7. Memory 804 typically (but not always) comprises both volatile memory 806 and non-volatile memory 808. Volatile memory 806 retains or stores information so long as the memory is supplied with power. In contrast, non-volatile memory 808 is capable of storing (or persisting) information even when a power supply is not available. Generally speaking, RAM and CPU cache memory are examples of volatile memory whereas ROM and memory cards are examples of non-volatile memory.

The processor 802 executes instructions retrieved from the memory 804 in carrying out various functions, particularly in responding to data clarification requests and search results queries from computer users on one or more user computers, such as user computer 102. The processor 802 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: mini-computers; mainframe computers, personal computers (e.g., desktop computers, laptop computers, tablet computers, etc.); handheld computing devices such as smartphones, personal digital assistants, and the like; microprocessor-based or programmable consumer electronics; and the like.

The system bus 810 provides an interface for search engine's components to inter-communicate. The system bus 810 can be of any of several types of bus structures that can interconnect the various components (including both internal and external components). The search engine 110 further includes a network communication component 812 for interconnecting the user computer with other computers (including, but not limited to, user computers 102-106) as well as other devices on a computer network 108. The network communication component 812 may be configured to communicate with an external network, such as network 108, via a wired connection, a wireless connection, or both.

The search engine 110 includes a query term clarification component 814 which is configured to identify clarification data corresponding to a query term from a clarification data store 820 in response to a data clarification request from a computer user 101 operating via a user computer 102. The query term clarification component 814 obtains clarification data from the clarification data store 820 based on the received query term in a clarification data request, user profile information stored in a user profile store 822 according to user information that may be supplied with a clarification data request, contextual data corresponding to the computer user 10, as well as any other intent clarifications that may already be known.

The search results retrieval component 816 identifies and/or retrieves content in the content store 824 that satisfies the search query. The search results retrieval component 816 identifies relevant content in a content store 824 according to the query terms of the search query, intent clarifications associated with the query terms of the search query, user profile information corresponding to the computer user 101 (obtained from the user profile store 822), contextual information corresponding to the computer user, and other information that may be useful in providing the most relevant content to the computer user. A search results page generator 818 uses the search results identified by the search results retrieval component 816 to generate one or more search results pages responsive to the search query from the computer user 101. At least one of the generated search results pages is then returned to the computer user 101 at the user computer 102 in response to receiving the search query.

In addition to using the intent clarifications to identify search results, the search page generator 818 may use the intent clarifications to personalize the search results page. For example, based on the intent clarifications, advertisements may be selected that are more accurately tailored to the computer user. Similarly, contextual information corresponding to the computer user may also be used in conjunction with the intent clarifications to enhance the generated search results page. Further still, in addition to applying the intent clarifications to the query (that the computer user enters) and to the generation of one or more search results pages, the intent clarifications may also be applied to the “auto-completion” search queries suggested to the computer user as the computer user enters the search query. Auto-completion search queries are known in the art and presented as selectable queries that are frequent and/or likely completions of the as the computer user types the search query. Auto-completion of search queries takes the position that the computer user has not finished entering the entire search query and the auto-completion process is attempting to assist the computer user in suggesting frequent and/or likely search queries.

Those skilled in the art will appreciate that the various components of FIGS. 7 and 8 described above may be implemented as executable software modules within the computer systems, as hardware modules, or a combination of the two. Moreover, each of the various components may be implemented as an independent, cooperative process or device, operating in conjunction with one or more computer systems. It should be further appreciated, of course, that the various components described above in regard to the user computer 102 and the search engine 110 should be viewed as logical components for carrying out the various described functions. As those skilled in the art appreciate, logical components (or subsystems) may or may not correspond directly, in a one-to-one manner, to actual, discrete components. In an actual embodiment, the various components of each computer system may be combined together or broke up across multiple actual components and/or implemented as cooperative processes on a computer network 108.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for clarifying intent of a computer user with regard to one or more query terms of a search query, the method comprising:
analyzing the search query to identify a first query term that is unclear;
obtaining clarification data relating to the first query term;
presenting a clarification user interface comprising at least a subset of the obtained clarification data;
receiving clarification data from the computer user via the clarification user interface; and
identifying the clarification data as an intent clarification for the identified query term.

2. The computer-implemented method of claim 1 further comprising:
submitting the search query and the intent clarification to a search engine;
obtaining search results responsive to the search query and intent clarification; and
presenting at least some of the search results to the computer user.

3. The computer-implemented method of claim 2 further comprising parsing the search query to identify a plurality of query terms, including the first query term.

4. The computer-implemented method of claim 3 further comprising scoring the plurality of query terms to determine a clarification value for each of the query terms indicative of the likelihood of clarifying the user intent with regard to the corresponding query term.

5. The computer-implemented method of claim 1, wherein the clarification data comprises clarification of a plurality of aspects with regard to the first query term.

6. The computer-implemented method of claim 1, wherein obtaining clarification data relating to the first query term comprises obtaining clarification data relating to the first query term from a local clarification data cache.

7. The computer-implemented method of claim 1, wherein obtaining clarification data relating to the first query term comprises submitting a clarification data request to a search engine and obtaining clarification data relating to the first query term from the search engine.

8. The computer-implemented method of claim 7, wherein the clarification data request comprises the query term for which clarification data is sought.

9. The computer-implemented method of claim 8, wherein the clarification data request further comprises user identification information to identify the requesting computer user to the search engine.

10. The computer-implemented method of claim 9, wherein the clarification data request further comprises contextual information corresponding to the computer user.

11. The computer-implemented method of claim 7, wherein the clarification data request further comprises previously received clarification data corresponding to the first query term.

12. A computer-readable medium bearing computer-executable instructions which, when executed on a computing system comprising at least a processor executing instructions retrieved from the medium, carry out a method for clarifying the intent of a computer user with regard to one or more query terms of a search query, the method comprising:
analyzing the search query to identify a first query term for clarification by the computer user;
obtaining clarification data relating to the first query term;
presenting a clarification user interface comprising at least a subset of the obtained clarification data;
receiving clarification data from the computer user via the clarification user interface;
identifying the clarification data as an intent clarification for the identified query term;
submitting the search query and the intent clarification to a search engine;
obtaining search results responsive to the search query and intent clarification; and
presenting at least some of the search results to the computer user.

13. The computer-readable medium of claim 12, wherein obtaining clarification data relating to the first query term comprises obtaining clarification data relating to the first query term from a local clarification data cache.

14. The computer-readable medium of claim 12, wherein obtaining clarification data relating to the first query term comprises submitting a clarification data request to a search engine and obtaining clarification data relating to the first query term from the search engine.

15. The computer-readable medium of claim 14, wherein the clarification data request comprises the first query term and a user identifier for identifying the computer user to the search engine.

16. The computer-readable medium of claim 15, wherein the clarification data request further comprises contextual information corresponding to the computer user.

17. The computer-readable medium of claim 12, wherein the method further comprising scoring the plurality of query terms to determine a clarification value for each of the query terms indicative of the likelihood of clarifying the user intent with regard to the corresponding query term; and
wherein analyzing the search query to identify first query term that is unclear comprises identifying a first query term having a clarification value exceeding a predetermined threshold value.

18. A computer system clarifying the intent of a computer user with regard to one or more query terms of a search query, the computer system comprising a processor and a memory, wherein the processor executes instructions stored in the memory as part of or in conjunction with additional components, comprising:
a search component configured to:
obtain a search query from the computer user;
obtain clarification data corresponding to a first query term of the search query and present at least some of the clarification data to the computer user for selection as the computer user's intent with regard to the query term;
associate clarification data with the first query term as an intent clarification;
submit the search query to a search engine along with the intent clarification associated with the first query term; and
present search results to the computer user, the search results being obtained from the search engine in response to submitting the search query; and
a query term analyzer that identifies an unclear query term of the search query as the first query term.

19. The computer system of claim 18, wherein the query term analyzer determines a clarification score for the query terms of the search query and identifies one of the query terms as first query term having a clarification value exceeding a predetermined threshold value as the first query term.

20. The computer system of claim 18 further comprising a clarification data cache, and wherein the search component is configured to obtain clarification data from the clarification data cache or from a search engine via a clarification data request, or both.
